(19) United States
(12) Patent Application Publication
(10) Pub. No.: US 2003/0096062 A1
(43) Pub. Date: May 22, 2003

(54) Antimicrobial metal coating process and product

(75) Inventor: Ethan S. Hoberman, New York, NY (US)

Correspondence Address: DELIO & PETERSON, 121 WHITNEY AVENUE, NEW HAVEN, CT, 06510

(73) Assignee: Sargent Manufacturing Company

(21) Appl. No.: 09/989,565

(22) Filed: Nov. 20, 2001

(51) Int. Cl. B05D 3/02

(52) U.S. Cl. 427/388.1

(57) ABSTRACT

A method is provided for making brass, bronze, chrome, steel, antique, and stainless steel finish metal or plastic products having enhanced antimicrobial and other properties without any significant discoloration of the metal product. A curable polymeric material containing ceramic particles preferably a zeolite with one or more antibiotic metals ion-exchanged therein is used and applied to the metal product and cured for an effective time at a specific temperature range to provide the desired metal product. Electrostatic spraying is preferred to coat the article but other application methods can be used.

### BACKGROUND OF THE INVENTION

1. Field of the Invention

The present invention relates to a metal finishing process and, more particularly, to making brass, bronze, chrome, steel, stainless steel, and antique finish metal or plastic products having enhanced antimicrobial and other properties without discoloration of the metal product.

2. Description of Related Art

Metals and metal plated plastics are used to make numerous products (hereinafter referred to as “metal parts, metal products, etc), which are frequently touched by people including plumbing fixtures, door accessories such as handles, appliances, and the like. Depending on the metal part to be made, the metal used may vary widely from a zinc die casting to steel to solid brass and solid bronze, and numerous plastics can be used such as polyethylene, polypropylene, etc. Various metal platings including chrome, brass, bronze, nickel, copper, zinc, gold, silver and the like may be applied to the substrates. For convenience, the following description will be directed to the use of solid brass and solid bronze to make door accessories such as door handles, but it will be appreciated by those skilled in the art that other metals and metal plated plastics may be used with the method of the invention.

The making of metal products typically requires a number of finishing steps after the fabrication steps such as polishing, buffing, metal plating, scouring, cleaning, etc. A clear impervious coating on the surface of the finished product is typically used to increase the corrosion resistance and wear resistance of the article. U.S. Pat. No. 5,558,759 to Pudem and assigned to Sargent Manufacturing Company, the assignee of the present invention, shows a metal finishing process utilizing the above finishing steps.

The metal finishing process may however result in discoloration of the metal product, especially for brass, bronze, chrome, antique finishes, steel and stainless steel finish products, and is a serious problem to manufacturers. This discoloration can occur from several factors such as contamination on the metal products in any of the stages up through the end of powder coating or through a tint, hue, or gloss change effected by the final coating.

Industry now requires antimicrobial coatings on many metal products because diseases can be transmitted from one person to another person merely by both parties contacting the same metal product. Such a metal product may be a door handle, toilet handle, waste container, utensils, water faucet and other products which come into contact with human beings.

Numerous products have been developed to form antimicrobial coatings on substrates such as metals. In U.S. Pat. No. 4,911,898, a polymer article is disclosed having antibacterial containing zeolite particles therein. The zeolite particles retain metal ions which show an antibacterial effect at the ion-exchange sites of the zeolite articles. The polymer article can be used to mold products or may be fluidized by dissolving or dispersing the product into a liquid which may be utilized in an antibacterial paint or a coating material. U.S. Pat. No. 5,238,749 discloses a thermoplastic and/or thermosetting resin incorporating an antimicrobial agent which is used to coat a substrate by electrostatic, fluidized bed or flame spraying technique. In one of the processes in this patent, a substrate is electrostatically coated with the antimicrobial polymer product and the substrate heated so that the resulting coating becomes tightly bonded to the substrate and molecularly cross-linked (cured). In U.S. Pat. No. 4,938,958 an antibiotic zeolite and an antibiotic resin composition are provided. The antibiotic zeolite is prepared by replacing all or a part of ion-exchangeable ions in the zeolite with ammonium ions and antibiotic metal ions such as silver, copper, zinc, etc. The antibiotic resin composition comprises the antibiotic zeolite and a resin such as polyethylene, polypropylene, PVC and polystyrene.

Antimicrobial mixtures are shown in U.S. Pat. No. 5,714,430 which contain silver with a small particle diameter on a neutral or basic non-zeolite carrier oxide. This mixture was developed for use on textile fibers where the silver is not leached out by washing and does not discolor on exposure to sunlight. It is theorized that ionically bound silver is precipitated as black AgO by alkalis, which leads to discoloration of the products and also that colloidal metal silver, while having bactericidal properties, has an intrinsically dark color so that it is not suitable for doping light-colored fibers, especially carpets.

An antimicrobial powder coating composition comprising an antimicrobial agent homogenously dispersed with particles of a resin-based powder is shown in U.S. Pat. No. 6,093,407. An article may be coated with the powder by electrostatic spray, dipping into a fluidized bed or by thermal or flame spray and when cured provides enhanced resistance to bacterial and fungal attack, while possessing excellent toughness, appearance, corrosion resistance, durability, processability and ease of application.

All the above patents are hereby incorporated by reference.

Antimicrobial resins when used to coat metal products having a brass, bronze, chrome, antique, steel or stainless steel finish have been found to discolor the finish of the metal product and is a serious problem which must be addressed by manufacturers.

Bearing in mind the problems and deficiencies of the prior art, it is therefore an object of the present invention to provide a method for making brass, bronze, chrome, antique, steel, or stainless steel finish metal or plastic products having enhanced antimicrobial and other properties while inhibiting discoloration of the product.

It is another object of the present invention to provide brass, bronze, chrome, antique, steel, or stainless steel finish metal or plastic products having enhanced antimicrobial and other properties made using the method of the invention.

Still other objects and advantages of the invention will in part be obvious and will in part be apparent from the specification.

### SUMMARY OF THE INVENTION

The above and other objects, which will be apparent to those skilled in art, are achieved in the present invention which relates in one aspect to a method for making brass, bronze, chrome, antique, steel, or stainless steel finish metal or plastic products having enhanced antimicrobial and other properties such as corrosion resistance, wearability, strength, UV protection, chemical resistance (especially perspiration resistance per ANSI/BHMA A156.18-2000), while inhibiting discoloration of the metal product comprising the steps of:

supplying a brass, bronze, chrome, antique, steel, or stainless steel finish metal or plastic product;

treating the metal or plastic product by polishing, buffing and/or scouring the metal or plastic product to obtain the desired finish;

cleaning the treated metal or plastic product if necessary;

applying a curable polymeric material containing ceramic particles preferably a zeolite with one or more ion-exchanged antibiotic metal cations therein; and

curing the coated metal or plastic product for an effective time at a defined temperature preferably of 380-390° F. for the curable aliphatic urethane polyester powder coating system described hereinbelow, to provide an antimicrobial coating having enhanced antimicrobial and other properties and no significant discoloration of the finished metal product article.

It is an important feature of the invention that the temperature of the curing step be controlled to avoid or minimize discoloration of the metal product. Another important feature of the invention is to use an antibiotic containing zeolite in a curable polymer as the coating for the metal product.

In another aspect of the invention a brass, bronze, chrome, antique, steel, or stainless steel finish metal or plastic product having antimicrobial products and no significant discoloration of the metal product is provided which product is made by the above method.

In still another aspect of the invention a brass finish zinc die cast, steel, stainless steel, bronze or plastic product having enhanced antimicrobial and other properties and no significant discoloration is provided comprising a zinc die cast, steel, stainless steel, bronze or plastic substrate, and in sequence, a copper plate, a nickel plate, and a brass plate, followed by a top antimicrobial coating comprising an antibiotic containing zeolite in a cured polymer matrix.

In a further aspect of the invention a bronze finish zinc die cast, steel, stainless steel, brass or plastic product having enhanced antimicrobial and other properties and no significant discoloration is provided comprising a zinc die cast or steel substrate, and in sequence, a copper plate and a bronze plate followed by a top coating of an antimicrobial coating comprising an antibiotic containing zeolite in a cured polymer matrix.

In another aspect of the invention a brass finish metal product having enhanced antimicrobial and other properties and no significant discoloration is provided comprising a solid brass substrate having an antimicrobial coating comprising an antibiotic containing zeolite in a polymer matrix. To form a bronze finish article, the solid brass article will have a copper plate followed by a bronze plate before the antimicrobial coating is applied.

In another aspect of the invention a bronze finish metal product having enhanced antimicrobial and other properties and no significant discoloration is provided comprising a solid bronze substrate having an antimicrobial coating thereon comprising a antibiotic containing zeolite in a polymer matrix. To form a brass finish article, the solid bronze metal article will have a metal plating such as, in sequence, a copper plate, nickel plate and a brass plate, preceding the top antimicrobial coating.

### DESCRIPTION OF THE PREFERRED EMBODIMENT(S)

As used herein, the term “polishing” is defined to be an operation in which coarse scratches or, in some instances, rough surfaces in the substrate surface left after forging, rolling, casting, or similar fabrication operations, are substantially removed to produce a substrate surface texture commensurate with a predetermined scratch pattern. Preferably, the polishing operation is implemented with an abrasive belt and a contact wheel, and the component to be polished is held against the contact wheel so the abrasive characteristics of the belt removes any material and imperfections in the component surface.

As used herein, the phrase “grain size” is defined to be the size of the grains on a particular abrasive belt. “Grain size” is also known in the art as “grit size”. The following grain sizes are referred to throughout the description of the present invention: (a) 100 (fine); (b) 150 (fine); (c) 180 (fine); (d) 200 (very fine); (e) 220 (very fine). The terms “fine” and “very fine” are used to generally describe the degree of coarseness of the grains or grit on an abrasive belt. The polishing processes described herein utilize abrasive belts having grain or grit sizes between 100-220.

As used herein, the phrase “scratch pattern” is defined to be the surface texture of the component or plating that results from polishing, refining or buffing the surface with an abrasive belt having a specific grain size. For instance, a #120 scratch pattern (or scratch pattern of 120) results when the surface is polished with an abrasive belt having a grain size of 120.

As used herein, the terms “buffing” or “refining” are defined to be finish polishing processes whereby abrasive belts having successively finer grain or grit sizes are applied to the component surface or plating surface so that coarse scratch patterns are transformed into fine or very fine scratch patterns. Very little material is removed from the component surface or plating surface during the buffing or refining steps. The buffing or refining processes described herein utilize abrasive belts having grain sizes of 200 and 220. Buffing wheels such as a treated, pleated cotton buff wheel such as the one supplied by Jackson Lea Inc. when used with a buffing compound such as Lea Rock 2929 and an untreated loose cotton buff wheel such as supplied by Jackson Lea Inc. when used with a buffing compound such as Lea Rock 349E are also used to provide the desired finish and color. The metal product is buffed by removing any roughness and non-adherent metal film on the surface of the component, and brightening the plated surface to a mirror-like luster for a bright brass, bronze or bright chrome (US3, US9 or US6) finish or scouring for a satin brass finish, satin brass bronze, or satin chrome (US4, US10 or US62D). Preferably, a loose buff made of several sections is utilized in conjunction with a greaseless color compound.

The process for producing a “satin” finish on a metal product comprises scouring the product during the finishing operation before applying any final impervious coating such as an antimicrobial coating. The scouring process generally comprises using a stitched or loose buff wheel such as an untreated loose buff wheel supplied by Jackson Lea with a commercial 200-grit greaseless compound. A satin finish can also be applied by a scotch bright wheel.

Any metal and plastic including zinc die castings, steel, cold rolled steel, stainless steel, solid brass and solid bronze and plastics such as polyethylene and polypropylene which are typically used to make metal products and metal finish products including door accessories may be used in the method of the invention.

If the metal product needs to be metal plated, any of the conventional electrolytic and electroless methods may be used as is well known in the art. Typical plating baths may be found in the “2001 Guidebook & Directory”.

A typical copper electroplating process, for example, is an electroplating process that comprises making the metal product cathodic; striking the metal product if necessary with a copper strike; plating the metal product with copper; treating the metal product to remove any residue; rinsing the metal product in water; and drying the metal product. A copper electroplating bath such as those described in the “2001 Guidebook & Directory” distributed by Metal Finishing Magazine may be used. A preferred commercial bath because of its demonstrated effectiveness is MacDermid Inc.'s Metex S-1 Semi-Bright Cyanide Copper Process.

If it is desired to make a brass finish product, the metal product is first plated with copper, then plated with nickel and then plated with brass.

Nickel is typically plated using an electrolytic nickel bath such as a NiMac Clarion Bright Nickel Process sold by MacDermid Incorporated. Electroless nickel baths can also be used.

A preferred commercial brass plating composition is an E-Brite™ B-150 brass plating bath sold by Electrochemical Products Inc. (EPI).

A commercial bronze plating composition is described in the “2001 Guidebook & Directory” on page 209.

If it is desired to make a bronze finish product, the metal product is first plated with copper and then plated with bronze.

The degreasing process entails removing any color buffing residue or other residues on the surface of the metal product, e.g. the brass or bronze article or electroplated deposit. This step is preferably implemented by applying a solvent, such as trichloroethylene in a vapor degreaser, to the surface of the plated component. This can also be accomplished by using aqueous cleaning systems such as ultrasonic cleaning, soak cleaning and electrocleaning.

The final step in the method of the invention is to deposit a substantially moisture impervious clear coating on the metal part, e.g., the bronze or brass metal part or plating, preferably by electrostatic coating of the article using the above curable antimicrobial powder composition and then curing the coated article under controlled temperature conditions.

While the type of antimicrobial product used to coat the finished metal product may vary as noted in the above patents, a highly preferred product because of its demonstrated effectiveness is made by DuPont under Laboratory Product Data No. 381149A and named Clear and is a curable aliphatic urethane polyester containing an AJ zeolite having ion-exchanged silver therein. The “zeolite” product is typically of Type AD, AG, AV, AW, AL, AJ, or AK as designated and provided by AglON™ Technologies of West Shefield, Mass. The zeolite is a zeolite A and the silver containing product is characterized by a specific gravity of 1.21±0.05 and a mass loss during curing of <6.12%. After curing the coating is characterized at a minimum by a gloss at 60° of 85+, a PCl powder smoothness of 7-8, a pencil hardness of H and a salt spray resistance of 1,000 hours as measured by ASTM B117-97. The curable product preferably contains 1-5% Type AJ but can contain the other type zeolites in a similar concentration.

Another product that can be used is a curable epoxy coating containing an antibiotic containing zeolite also produced by DuPont. This coating can be cured at lower temperatures 315-340° F., but is less desirable due to poorer overall product performance such as when subjected to ultraviolet light per ANSI/BHMA A156.18-2000.

The DuPont Clear Powder #381149A contains the AglON™ Silver Antimicrobial Type AJ at about 2% by weight. Higher concentrations up to about 5% or more can be used.

It is preferred to apply the powder to the metal product cold (room temperature) by electrostatic spray. Other application methods may be used such as fluidized bed, flame spray or as a paint. The coated thickness is typically about 1.0 to 1.5 mil, but can be up to 3-4 mil or more.

Following surface preparation, the substrate is grounded. Negatively charged particles of the curable antimicrobial powder are applied to the substrate by electrostatic powder coating at high voltage typically 75 to 100 KV.

It is an important feature of the invention that the preferred coating be cured at a temperature less than about 390° F. to avoid discoloration of the product when using the preferred Dupont aliphatic urethane polyester and highly preferred to cure the coating at about 380° F.-390° F. to obtain a commercially acceptable metal product article. In addition to avoiding discoloration, when cured above 390° F., the coating does not perform as effectively to the ANSI/BHMA standard for “perspiration testing.” However, the coating will still pass the minimum requirements for perspiration when cured at temperatures above 390° F.

Zeolite is in general an aluminosilicate having a three dimensional skeletal structure and represented by the formula: XM2/nO—Al₂O₃—YSiO₂-ZH₂O. In the general formula, M represents an ion-exchangeable ion and in general a monovalent or divalent metal ion, n represents atomic valency of the (metal) ion, X and Y represent coefficients of metal oxide and silica respectively, and Z represents the number of water of crystallization. Examples of such zeolites include A-type zeolites, X-type zeolites, Y-type zeolites, T-type zeolites, high-silica zeolites, sodalite, mordenite, analcite, clinoptilolite, chabazite and erionite. However, the present invention is not restricted to these specific examples and the A type is preferred because of its demonstrated effectiveness. All the zeolites listed above have ion-exchange capacity sufficient to undergo ion exchange with antibiotic metal ions.

In the antibiotic zeolite of the present invention, ion-exchangeable ions present in the zeolite, such as sodium ions, calcium ions, potassium ions and iron ions are completely or partially replaced with antibiotic metal ions and preferably also with ammonium ions. Examples of the antibiotic metal ions include ions of silver, copper, zinc, mercury, tin, lead, bismuth, cadmium, chromium and thallium. Preferably the antibiotic metal ions are silver. In the present invention, it is preferable that the zeolite contains about 2 to 5% silver ions. Ammonium ions can be ion-exchanged, and it is desirable that the content of ammonium ions in the zeolite be in range of about 0.5 to 15%, preferably 1.5 to 5% as described in U.S. Pat. No. 4,938,958, supra.

The method of the invention will be explained in more detail with reference to he following non-limitative examples.

### EXAMPLES

### Example 1

To make a bright brass metal product on a solid brass substrate the following steps were used:

1) 1^{st} Polish

120-150 grit belt

2) 2_{nd} Polish

220 grit belt

3) Hard Buff

Stitched treated buff wheel made of pleated cotton.

Rough buffing compound Lea Rock 2929.

4) Color Buff

Stitched untreated buff wheel made of unpleated cotton.

Color buffing compound Lea Rock 349E.

5) Vapor Degrease

6) Electrostatically Coat with DuPont Antimicrobial Powder #381149A

7) Cure at 390° F. for 12 minutes

### Example 2

To make a satin brass metal product on a solid brass substrate the following steps were used:

1) Polish

120-150 grit belt

2) Scour

Greaseless compound 200 or 220 grit

Loose untreated buff wheel.

3) Electrostatically Coat with DuPont Antimicrobial Powder #381149A

4) Cure at 390° F. for 12 minutes

### Example 3

To make a satin bronze metal product on a solid bronze substrate the following steps were used:

1) Polish

120-150 grit belt

2) Scour

Greaseless compound 200 or 220 grit

Loose untreated buff wheel.

3) Electrostatically Coat with DuPont Antimicrobial Powder #381149A

4) Cure at F-390° F. for 12 minutes

### Example 4

To make a bright bronze metal product on a solid bronze substrate the following steps were used:

1) 1^{st} Polish

120-150 grit belt

2) 2^{nd} Polish

220 grit belt

3) Hard Buff

Stitched treated buff wheel made of pleated cotton.

Rough buffing compound Lea Rock 2929.

4) Color Buff

Stitched untreated buff wheel made of unpleated cotton.

Color buffing compound Lea Rock 349E.

5) Vapor Degrease

6) Electrostatically Coat with DuPont Antimicrobial Powder #381149A

7) Cure at −390° F. for 12 minutes

In all the examples the electrostatic coating was applied at ambient temperatures of approximately 72° F. using an electrostatic spray system. A coating thickness of about 1 to 2 mil was formed. None of the products made had any significant discoloration and were commercially acceptable.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1 A method for making metal or metal finish plastic products having enhanced antimicrobial and other properties such as corrosion resistance, wearability, strength, UV protection, chemical resistance (especially perspiration resistance per ANSI/BHMA A156.18-2000), while inhibiting discoloration of the metal product comprising the steps of:
supplying a metal or metal finish plastic product;
treating the metal or plastic product by polishing, buffing and/or scouring the metal or plastic product to obtain the desired finish;
cleaning the treated metal or plastic product if necessary;
applying a curable polymeric material containing a zeolite with one or more ion-exchanged antibiotic metal cations therein; and
curing the coated metal product for an effective time at a defined temperature of 380°-390° F. to provide an antimicrobial coating having enhanced antimicrobial and other properties and no significant discoloration of the finished metal product article.

2. The method of claim 1 wherein the curable polymer is an aliphatic urethane polyester.

3. The method of claim 1 wherein the metal or plastic product has a brass, bronze, chrome, antique, steel or stainless steel finish.

4. The method of claim 3 wherein the metal or plastic product has a brass or bronze finish.

5. The method of claim 4 wherein the product is a solid brass or solid bronze product.

6. The method of claim 1 wherein the curable polymeric material is a silver containing zeolite in a curable aliphatic urethane polyester.

7. As an article of manufacture a metal or plastic product made by the method of claim 1.

8. As an article of manufacture a metal or plastic product made by the method of claim 2.

9. As an article of manufacture a metal or plastic product made by the method of claim 3.

10. As an article of manufacture a metal or plastic product made by the method of claim 4.

11. As an article of manufacture a metal or plastic product made by the method of claim 5.

12. As an article of manufacture a metal or plastic product made by the method of claim 6.
